(19) United States
(12) Patent Application Publication
(10) Pub. No.: US 2024/0349175 A1
(43) Pub. Date: Oct. 17, 2024

(54) DEVICE CAPABILITY COORDINATION METHOD AND APPARATUS

(71) Applicant: ZTE Corporation, Shenzhen (CN)

(72) Inventors: Wenting LI, Shenzhen (CN); He HUANG, Shenzhen (CN); Jing LIU, Shenzhen (CN)

(21) Appl. No.: 18/750,193

(22) Filed: Jun. 21, 2024

Related U.S. Application Data
(63) Continuation of application No. PCT/CN2022/105522, filed on Jul. 13, 2022.

(51) Int. Cl. H04W 48/16; H04W 28/02; H04W 76/27

(52) U.S. Cl. CPC H04W 48/16; H04W 28/0215; H04W 76/27

(57) ABSTRACT

A method of wireless communication includes transmitting, by a wireless device, to a first network device of a first wireless network a capability restriction message indicative of a temporary restriction of one or more capabilities of the wireless device for operation in the first wireless network, wherein the capability restriction message indicates a forbidden capabilities set using an explicit indication in which bit fields indicating a first set of capabilities subject to the temporary restriction are included, or an implicit indication in which a second set of capabilities subject to the temporary restriction is indicated by omitting corresponding bit fields from the capability restriction message; and receiving, by the wireless device, from the first network device, a response indicative of an action performed by the first network device in response to the capability restriction message.

### CROSS-REFERENCE TO RELATED APPLICATION

This application is a continuation and claims priority to International Application No. PCT/CN2022/105522, filed on Jul. 13, 2022, the disclosure of which is hereby incorporated by reference herein in its entirety.

### TECHNICAL FIELD

This document relates to systems, devices and techniques for wireless communications.

### BACKGROUND

Efforts are currently underway to define next generation wireless communication networks that provide greater deployment flexibility, support for a multitude of devices and services and different technologies for efficient bandwidth utilization.

### SUMMARY

This document describes technologies, among other things, techniques for coordination between a wireless network and a user device of capabilities of the user device currently being used in the wireless network.

In one example aspect, a method of wireless communication is disclosed. The method includes transmitting, by a wireless device, to a first network device of a first wireless network a capability restriction message indicative of a temporary restriction of one or more capabilities of the wireless device for operation in the first wireless network, wherein the capability restriction message indicates a forbidden capabilities set using an explicit indication in which bit fields indicating a first set of capabilities subject to the temporary restriction are included, or an implicit indication in which a second set of capabilities subject to the temporary restriction is indicated by omitting corresponding bit fields from the capability restriction message; and receiving, by the wireless device, from the first network device, a response indicative of an action performed by the first network device in response to the capability restriction message.

In another example aspect, a method of wireless communication is disclosed. The method includes performing, by a wireless device, to a network device, a transmission of a medium access control (MAC) control element (CE) or a radio resource connect (RRC) message that indicative of removal of a temporary restriction of one or more capabilities of the wireless device for operation in the first wireless network.

In another example aspect, a method of wireless communication is disclosed. The method includes receiving by a first network device of a first wireless network, from a wireless device, a capability restriction message indicative of a temporary restriction of one or more capabilities of the wireless device for operation in the first wireless network, wherein the capability restriction message indicates a forbidden capabilities set using an explicit indication in which bit fields indicating a first set of capabilities subject to the temporary restriction are included, or an implicit indication in which a second set of capabilities subject to the temporary restriction is indicated by omitting corresponding bit fields from the capability restriction message; and transmitting, by the first network device to the wireless device, a response indicative of an action performed by the first network device in response to the capability restriction message.

In another example aspect, a method of wireless communication is disclosed. The method includes receiving by network device from a wireless device, a transmission of a medium access control (MAC) control element (CE) or a radio resource connect (RRC) message that indicative of removal of a temporary restriction of one or more capabilities of the wireless device for operation in the first wireless network.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 shows an example procedure for a UE capability restriction indication and removal process.

FIG. 2 shows an example of an enhanced procedure for UE capability restriction indication.

FIG. 3 shows examples of forbidden or allowed capability lists.

FIG. 4 shows another example of a forbidden or allowed capability list.

FIG. 5 shows examples of wireless systems in which capability restriction indication or removal may be implemented.

FIG. 6 shows an example process of capability restriction indication or removal in a multi-input multi-output (MIMO) wireless system.

FIG. 7 shows an example of a UE capability restriction removal process.

FIG. 8 shows an example of a UE capability restriction removal process.

FIG. 9 depicts examples of wireless systems in which UE capability restriction indication or removal may be implemented.

FIG. 10A-10B are flowcharts example wireless communication methods performed by a user device.

FIG. 11A-11B are flowcharts of example wireless communication methods performed by a network device.

FIG. 12 is a block diagram of an example of a wireless communication apparatus.

FIG. 13 shows an example wireless communications network.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

In 3GPP networks, a universal subscriber identity module, USIM, is an entity that stores subscriber-related information and implements the security functions pertaining to authentication and ciphering on the user side in a wireless network. One USIM may contain many profiles, each destined for certain purposes such as data, multimedia, etc. Most present-day user devices (e.g., user equipment UE such as mobile phones or tablets) are configured to accept a single USIM module.

For a MUSIM (Multi-USIM) UE, there would be some temporary capability limitation when the UE works at dual active state with two networks, e.g., UE is connected to the network A, the UE need to indicate the capability restriction when the UE enters into the connected state with network B. However, presently, there is no method available to provide such a seamless operation between different networks without UE experiencing a degradation in performance and/or user experience. The present document provides techniques that may be used by embodiments to manage the temporary UE capability restriction.

### Initial Discussion

In Rel 17 of the 5G protocol, the Multi-SIM technology was studied, and for the Multi-SIM Device, the UE may connect to the Multi-network at the same time, which need the UE capability coordination. Besides, in the Rel 16, the RACS (Radio Access capability signaling) was studied, which packet the UE radio access capability as a predefined or network defined UE capability ID.

For the Multi-SIM, the UE may connect to multiple networks simultaneously for different cases:

Paging receiving on SIM2 when the other card (SIM1) is at connected state, it can also be solved by time division multiplexing (TDM), e.g., reserving the scheduling gap for the SIM2, then there would be no cooperation for that there was not simultaneously connection with 2 networks. However, for the dual RX UE, this scheme will affect the performance of SIM1 by reserving scheduling gap with paging period. Another solution for the dual Rx UE is to reserve part of radio frequency or physical layer (RF/PHY) resources for the Paging Receiving.

Short dual Connected state: for example, the SIM1 was at connected state, but the SIM2 has to do some Mobility update, e.g., Periodic Registration, moving into a new Registration area, or response the paging. For this case, the UE will need capability cooperation during the short dual Connected state.

Long dual Connected state: the UE will have a voice call on SIM1, meanwhile have some other data service on SIM2. For this case, the UE need capability cooperation.

In the upcoming Release 18 a work item description (WID) on the MUSIM enhancement was proposed with the below description:

MUSIM UE's hardware capabilities are shared by the SIMs, and to use the hardware efficiently and economically, the related capabilities need to be dynamically split between the two SIMs. This can lead to a temporary hardware conflict for the UE, which may require UE to release some resources (e.g., SCell/secondary cell group SCG) from one SIM. For example, when the UE's SIM A is in radio resource control (RRC) connected state in Network A while the UE's SIM B is in RRC Idle or RRC Inactive in Network B, the two RF chains will be occupied by the SIM A for the communication in Network A. Once the UE's SIM B enters into RRC connected state, one of the RF chains needs to be switched to SIM B. In this case, if the Network A is not aware of the UE's reduced capability change in RF chain, there may be data loss due to demodulation failure and wasting radio resources in Network A. To avoid this, assistance from UE to network A on these temporary UE (capability) restrictions can be beneficial.

### 0. General Procedure

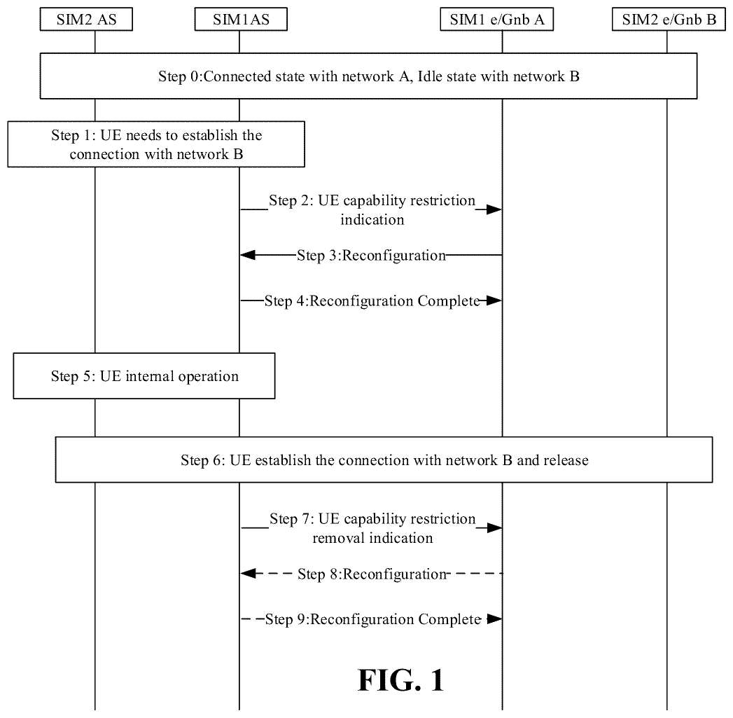

FIG. 1 shows an example of a general procedure for the UE capability restriction indication and removal procedure. In FIG. 1 and subsequent figures, the entities performing message exchange include: SIM1 AS (access stratum functionality of first SIM), SIM2AS (access stratum functionality of second SIM), eGnB A (base station for network A), eGnB B (base station for network B).

For the UE capability update procedure, generally, when the UE is working in a connected state in network A (step 0) and the UE needs to establish the connection with network B (step 1), the UE would indicate the UE capability restriction to the network A (step 2) and wait for the network A's response (e.g., a Reconfiguration message in step 3). Subsequently, a reconfiguration complete message may be sent in step 4, and UE may proceed to perform additional operations (Step 5). Then, after the UE release the connection from the network B (step 6), the UE would indicate the UE capability restriction removal to the network B (step 7). This may be followed by step 8 (reconfiguration of the UE's capabilities) and an acknowledgement from the UE that reconfiguration is complete (Step 9).

As shown in FIG. 1, in Step 2, UE transmits a capability restriction message and in Step 7, UE transmits a capability removal message. The present application provides, among other things, enhancements to steps 2 and 7 of the general procedure.

### 1. Enhancement to the General Procedure

During the general procedure, in various embodiments, UE can either receive a reconfiguration message or an indication from the network that it has received/reject the request.

The network may indicate acceptance of the UE's request implicitly or explicitly. Here, explicitly means that the network may include an accept indication in the configuration message. Alternatively, implicitly means that the network may configure the UE using a configuration message, where the configuration message can indicate SCG (secondary carrier group) release/Deactivate, Scell release/Deactivate, reduced MIMO (multi-input multi-output) layers and other PHY/RF parameters configuration, an accept indication or any combination thereof. This reconfiguration thus implicitly provides an indication to the UE that the network has received and/or accepted the temporary capability restriction. The network can also indicate reject the temporary capability restriction in the reconfiguration message or in other RRC message or a MAC CE (medium access control control element).

For the case that the temporary UE capability restriction requested by the UE may not affect the configuration, the network can send an indication to the UE that the network has received the request. This indication can be included in the reconfiguration message or in other RRC message or the MAC CE.

When the current serving band or band combination cannot be used based on the reported restricted capability, the network can release or redirect/handover the UE to the other available band or band combination.

A prohibit timer can be introduced to prevent UE from reporting temporary capability restriction frequently.

### Example 0: Procedure Enhancement

In the step 2 as above, the reconfiguration message can indicate SCG release/Deactivate, Scell release/Deactivate, reduced MIMO layers and other PHY/RF parameters configuration, an accept indication or any combination of them. An accept indication may be used to indicate the UE that the network has received or accept the temporary capability restriction. The network can also indicate reject/accept the temporary capability restriction in the reconfiguration message or in other RRC message. The network can also release the connection as in the step 2b.

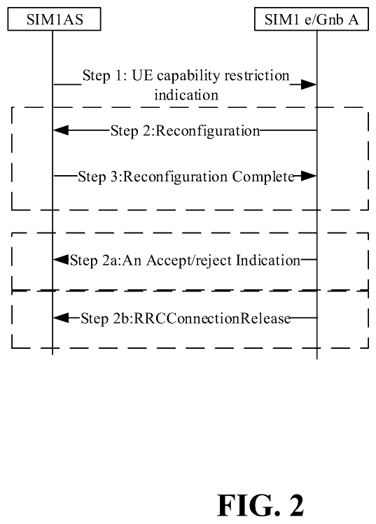

FIG. 2 shows an example of procedure enhancement in which the following steps may be performed:

Step 1: UE transmits, and network device receives, a UE capability restriction indication.

Step 2: Network device transmits and UE receives a reconfiguration message in which network device may indicate a reconfiguration to the UE.

Step 3: UE may optionally send, and network device may receive, a reconfiguration complete message.

Within this framework, the following messages may also be used:

Step 2a: Network device sends and UE receives an acceptance or rejection indication.

Step 2b: Network device transmits and UE receives an RRC connection release message.

### 2. Temporary UE Capability Update/Restriction

### 2.1 how to Report the Temporary UE Capability Restriction

UE report temporary UE capability restriction by indicating forbidden UE capabilities explicitly or implicitly the UE can indicate:
one or more forbidden BC (band combinations),
one or more forbidden band,
one or more forbidden feature set entry for a BC that is not being restricted,
one or more forbidden feature set band combination for the corresponding BC(s) that are not being restricted.

For the implicitly indication method, the UE may indicate allowed information as below:
one or more allowed BC,
one or more allowed band,
one or more allowed feature set entry for the corresponding BC that is not being restricted,
one or more allowed feature set combination

These temporary UE capability restrictions can be included in the RRC message, e.g. a UE assistance information message.

All of above information can be reported with index method, the index is used to indicate the position of the corresponding elements in the original UE capability information.

The UE can indicate SCG release/Deactivate, Scell release/Deactivate implicitly with the above temporary capability restriction.

### Example 1: Forbidden or Allowed Band List

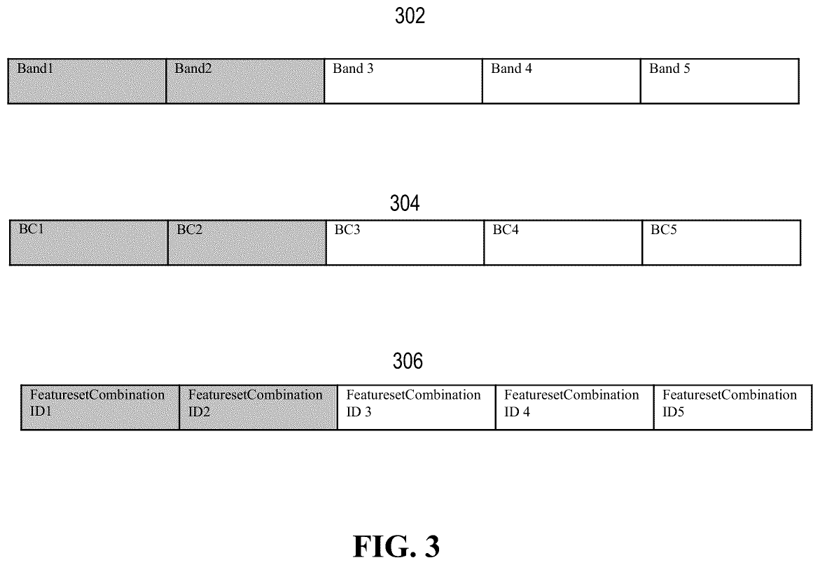

If the UE cannot access the band 1/band 2, the UE can include Band1/Band2 into the forbidden band list, which can be expressed by the Band index based on the pre-reported UE capability. This example is depicted in FIG. 3, example list 302.

Forbidden Band list [1][2]

Or Allowed Band list [3][4][5].

### Example 2: Forbidden or Allowed BC List

If the UE can't access BC1/BC2, the UE can include BC1/BC2 into the forbidden bandcombination list, which can be expressed by the BC index based on the pre-reported UE capability This example is depicted in FIG. 3, example list 304.

### Supportedbandcombinationlist

Forbidden BC list [1][2]
Or Allowed BC list [3][4][5]

### Example 3: Forbidden or Allowed FeaturesetCombination ID List

For a BC that support DC, there would be a FeatureSetCombination to indicate the supported RF/Base-band capabilities as below in Table 1.

```
TABLE 1
      FeatureSetCombination ::= SEQUENCE (SIZE
(1..maxSimultaneousBands)) OF FeatureSetsPerBand
      FeatureSetsPerBand ::= SEQUENCE (SIZE (1..maxFeatureSetsPerBand))
OF FeatureSet
      FeatureSet ::= CHOICE {
  eutra SEQUENCE {
    downlinkSetEUTRA FeatureSetEUTRA-DownlinkId,
    uplinkSetEUTRA FeatureSetEUTRA-UplinkId},
  nr SEQUENCE {
    downlinkSetNR FeatureSetDownlinkId,
    uplinkSetNR FeatureSetUplinkId}
```

If the FeaturesetCombination ID x can't be adopted for any BC, then the UE can indicate FeaturesetCombination ID x to the forbidden FeaturesetCombination ID list. This example is depicted in FIG. 3, example list 306.

Forbidden FeaturesetCombination ID list [1][2]

Or Allowed FeaturesetCombination ID list [3][4][5]

### Example 4: Forbidden or Allowed Featureset Entry List

In the current UE capability structure, for each BC, there would be a FeaturesetCombination. For each FeaturesetCombination, there would be one or more feature set combinations, take the BC1 as below as an example, there are 3 feature set combinations.

For example, BC1->FeaturesetCombination ID x

$$( \begin{matrix}Band 1 & Band 2 & Band 3 & BC 1 \\ {FeatureSet}_{1.1} & {FeatureSet}_{2.1} & {FeatureSet}_{3.1} & 1 \\ {FeatureSet}_{1.2} & {FeatureSet}_{2.2} & {FeatureSet}_{3.2} & 2 \\ {FeatureSet}_{1.3} & {FeatureSet}_{2.3} & {FeatureSet}_{3.3} & 3\end{matrix} )$$

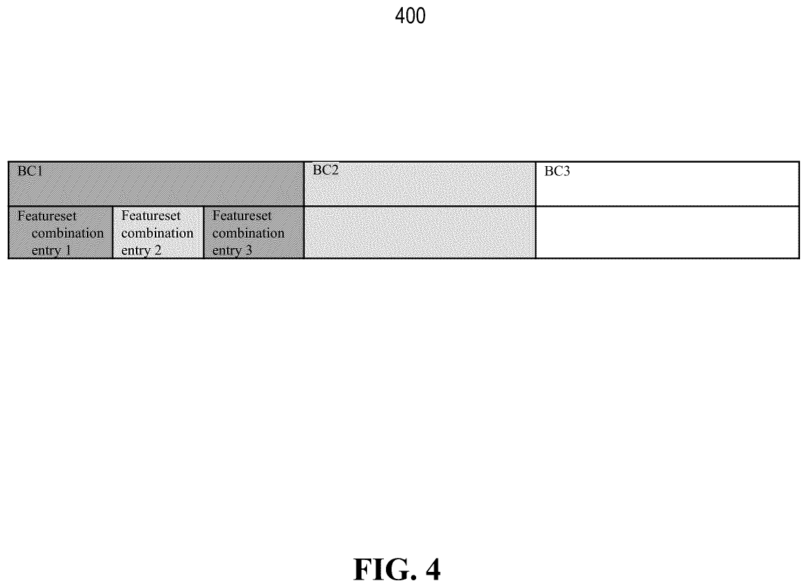

If for the BC1, the UE can only support feature set combination entry 1, 3, then the UE can indicate forbidden feature set combination entry 2 into the forbidden feature set entry list for the BC 1. This is shown in FIG. 4, example list 400.

Forbidden BC list [2]

Then for the BC1, report the

Forbidden feature set entry list [2],

Or Allowed feature set entry list [1][3]

The UE may indicate more BC similar to the BC1.

The below structure in Table 2 can be used, in which an BC index was used to indicate the position of a band combination in the supported Band Combination List that reported in the original UE capability information. While featureSetEntry Index is used to indicate which feature set Entries are forbidden/allowed in the corresponding FeaturesetCombination ID.

TABLE 2

| BandCombinationInfoList ::= | SEQUENCE (SIZE (1..maxBandComb)) OF |
|---|---|
| BandCombinationInfo | |
| BandCombinationInfo ::= | SEQUENCE{ |
| bandCombinationIndex | , |

forbiddenFeatureSetsList (or allowedFeatureSetList) SEQUENCE(SIZE
(1..maxFeatureSetsPerBand)) OF FeatureSetEntryIndex
}

### 2.1.1 Further Detail on the Forbidden BC/Featureset Entry Reporting

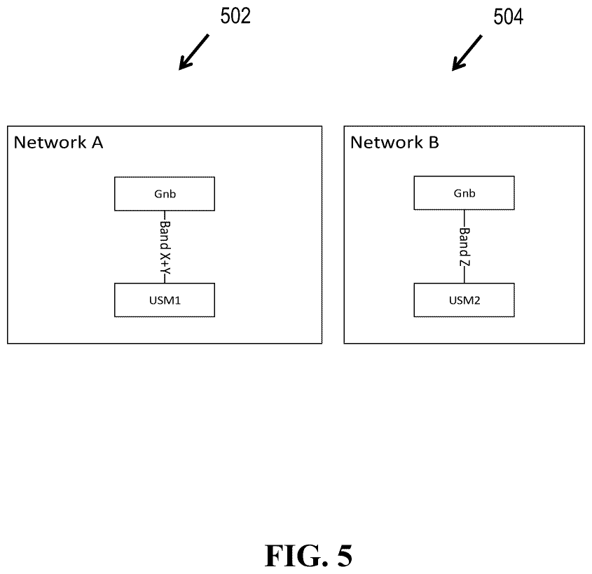

In a MUSIM situation, only the UE can see the bands of each network, so it should be the UE to decide on how to resolve the dependency between two networks. The UE can determine the temporary capability restriction as above and then send them to the network A. For the band combination, the UE would report the supported BC list when the network requires the UE capability with UECapabilityEnquiry message. In the UECapabilityEnquiry message, there may be a band filter, the UE would report the BC with the band that included in the filter. So based on whether a particular band Z (network B band) was included in the UE capability filter, there are 2 cases (as depicted in FIGS. 5, 502 and 504).

Case 1: The band Z was included in the UE capability filter

Case 2: The band Z was not included in the UE capability filter

### Example 5: Case 1 the Band Z was Included in the UE Capability Filter

For example, the UE is working at band X+Y at the network A, while the band of network B is noted as band Z. The X/Y/O/P/Z are included in the UE capability filter. Then we note the bandcombination with band Z as BC 1-4 as below:

$$BC 1 : X + Y + Z$$

$$BC 2 : X + O + Z$$

$$BC 3 : P + Y + Z$$

$$BC 4 : O + P + Z$$

Wherein the BC1/2/3 can be selected, with the BC4 was forbidden for the MUSIM case.

For this case, the UE can report the one or more BC within BC1/2/3 with the corresponding available feature set Entry list, and/or report BC4 in the forbidden BC list.

It can also indicate the band Z of the network B to the network A. For the case that the UE works with carrier aggregation (CA) or dual connectivity (DC), the UE can also indicate the Band combination of network B to the network A.

Then the network A can determine which band or BC with which feature set Entry can be used at the network A.

### Example 6: Case 2 the Band Z was Included in the UE Capability Filter

For example, the UE is working at band X+Y at the network A, while the band of network B is noted as band Z. The X/Y/O/P are included in the UE capability filter. Then we note the bandcombination as BC 1-4 as below:
BC1: X+Y
BC2: X+O
BC3: P+Y
BC4: O+P

Wherein the BC1/2/3 can be selected which the BC4 was forbidden for the MUSIM case.

For this case, the UE can report the BC index [1,2,3] that corresponding to (X+Y)(X+O)(P+Y) with the corresponding available Featureset entry list. and/or report BC(O+P) BC[4] in the forbidden BC list

2.1.2 how does the Network to Configure the UE to Report Temporary UE Capability Restriction

The network can indicate which kind of UE capability restriction was supported by the network, e.g.
SCG release/Deactivate
Scell release/Deactivate
Max CC/MIMO layer limitation
Forbidden/allowed Band or BC or feature set combination or feature set Entry list

Alternatively, the network may only indicate the UE to report temporary UE capability restriction through RRC message e.g., otherconfig in the Reconfiguration message.

### 2.2 Other Details on the Temporary UE Capability Reporting

There are also some other options for the UE capability reporting such as below

Option 1: UE report several temporary UE capability sets with an index when registration, then in the UAI or the MAC CE, the UE indicate the preferred Index.

Option 2: UE report dedicated temporary UE capability set.

Option 3: UE report some critical UE capability parameters (the max MIMO layer, max CC numbers as the power saving/overheating) in the UAI (UE assistance information).

If only MIMO layer and CC numbers were involved, the MAC CE may be adopted. For the scell activate/Deactivate, the legacy MAC CE can be adopted, while for the MIMO layer, a new MAC CE can be introduced.

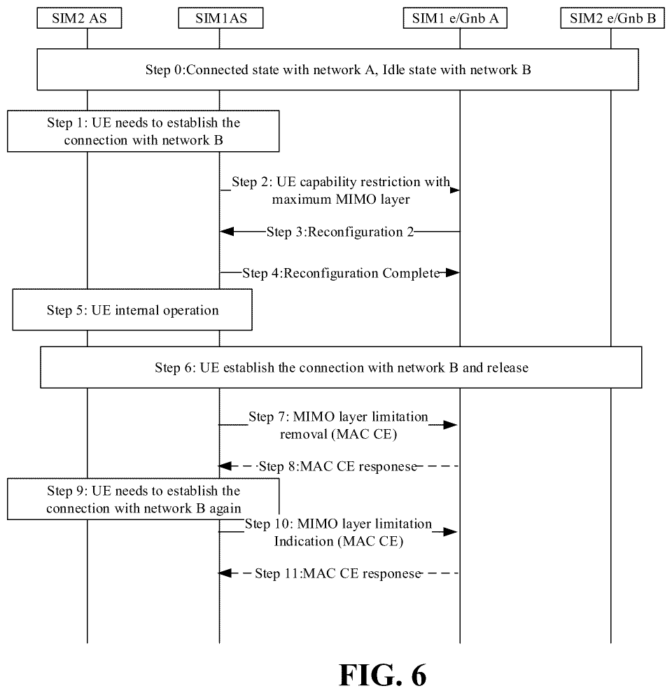

FIG. 6 shows an example procedure for the above-described options. With reference to FIG. 6, the following steps may be implemented.

Step 0: A MUSIM UE is in a connected state with network A and idle state with network B.

Step 1: UE wants to establish connection with network B.

Step 2: UE sends a capability restriction message to network A indicating maximum MIMO layers that the UE will support after the reconfiguration.

Step 3: UE receives a reconfiguration response from the network A.

Step 4: UE sends a confirmation that reconfiguration is complete (this step is optional).

Step 5: UE continues with additional operations.

Step 6: UE establishes a connection with network B. At some time later on, UE wishes to release connection with network B.

Step 7: UE sends a message to network A that UE wants to remove the restriction on maximum MIMO layers. This message may be sent as a MAC CE.

Step 8: UE receives a response from network A.

Step 9: At a later time, UE may want to establish a connection with network N again.

Step 10: UE may again send a MIMO layer limitation message to network A.

Step 11: In response, network A may send a response to the UE.

### 2.3 UE Temporary Capability Restriction Removal Indication

When the UE need to remove the restriction as in the general procedure step 7, generally, there are two possibilities:

### UAI Based

the UE can indicate UE temporary capability restriction removal implicitly or explicitly.

Implicitly means that the UE doesn't include anything in the Temporary capability restriction of the UAI (e.g., Table 3)

TABLE 3

UAI:
Temporary capability restriction { }

In embodiments that use explicit indication, UE transmits an indication to indicate remove restriction or back to the original UE capability.

When send the UE temporary capability restriction removal indication, the network can reconfigure the UE or send an indication to indicate the UE that it has received the removal indication with a RRC message or a MAC CE.

### MAC CE Based

The UE indicate UE temporary capability restriction removal with a MAC CE. the network can reconfigure the UE or send an indication to indicate the UE that it has received the removal indication with a RRC message or a MAC CE

### Example 7: UE Capability Restriction Removal 1

The typical case is that the network doesn't need to reconfigure the UE with the UE temporary capability restriction.

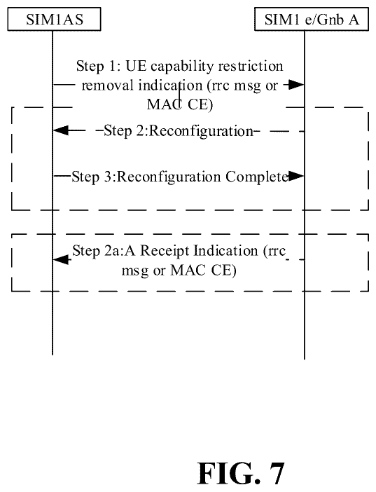

FIG. 7 shows an example of this embodiment. In FIG. 7, the following operations may be performed:

Step 1: UE sends a capability restriction removal indication. This may be an RRC message or a MAC CE.

Step 2: network A may respond by a reconfiguration message.

Step 3: UE may confirm the reconfiguration by transmitting a reconfiguration complete message.

Step 2A: Network A may send a receipt indication to the UE. This may be carried as an RRC message or a MAC CE.

### Example 8: Typical Case for the MAC CE

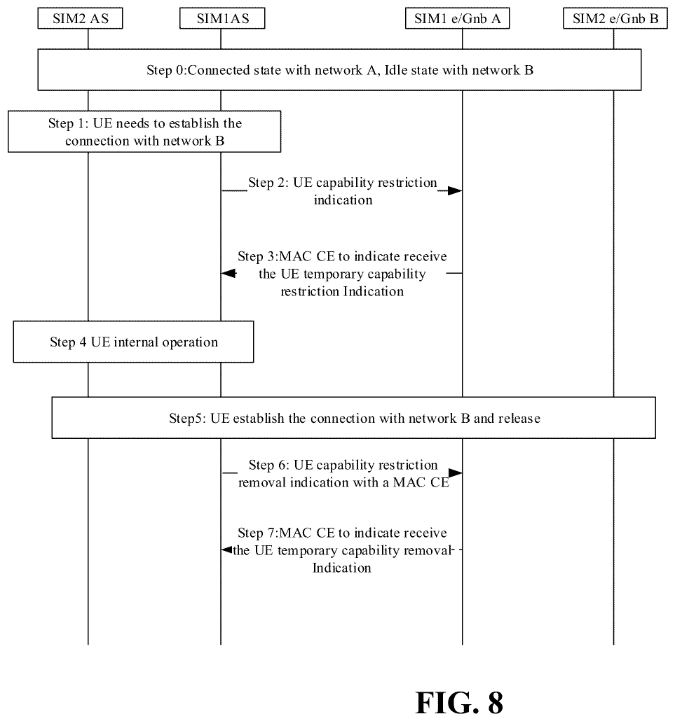

FIG. 8 shows an example procedure for this embodiment. With reference to FIG. 8, the following steps may be implemented:

Step 0: UE may be in a connected state with network A and in idle mode with network B.

Step 1: UE may want to establish a connection with network B.

Step 2: UE sends a capability restriction message to network A.

Step 3: UE receives a temporary UE capability restriction indication transmitted by the network A.

Step 4: UE may perform additional operations.

Step 5: At a later time, UE may establish a connection with network B. After some time, UE may want to release network B connection.

Step 6: UE sends a capability restriction removal indication that is received by network A.

Step 7: UE receives a temporary capability restriction removal indication transmitted by the network A.

### 2.4 Other Solutions on the Temporary UE Capability Restriction

The UE can indicate SCG release/Deactivate or Scell release/Deactivate to the network in the UAI for the temporary capability restriction.

### 2.4.1 SCG/Scell Release/Deactivate

From the SCG/Scell management aspect, the network can execute the below operations:
SN release
SCG release

(Note: From the UE side, the UE cannot distinguish SN release and SCG release, so from the UE UAI reporting aspect, only SCG release is considered).

SCG deactivation

De-configure CA (Scell Release)

SCG release

In the legacy power saving, the UE implicitly indicate a preference for NR SCG release by indicating zero number of carriers and zero aggregated maximum bandwidth in both FR1 and FR2. Furthermore, the SCG preference information is transparent to the MN.

For the MUSIM, there would be 2 options:
Option 1: Similar to the power saving, but the UE indicate the SCG release explicitly
Option 2: The UE indicate the SCG release preference for the MUSIM to the MN node explicitly (Cause value)

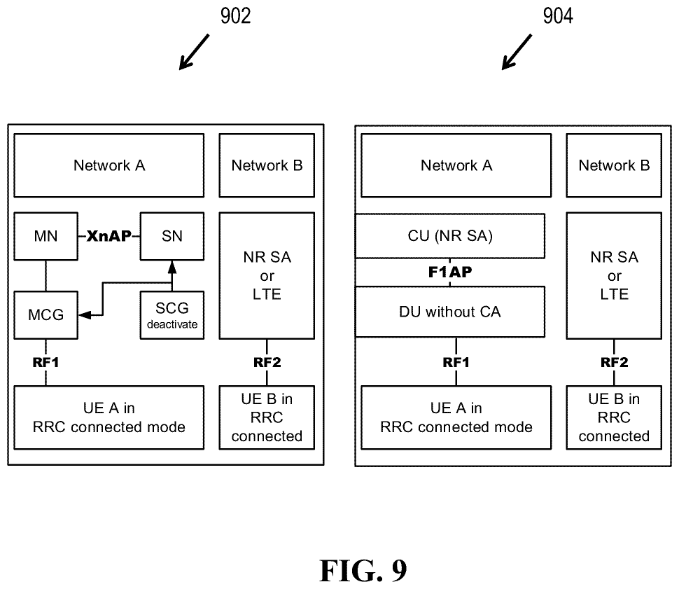

FIG. 9 shows to example situations as described above. Setup 902 depicts a scenario in which network A comprises an MN and SN, where SCG may be deactivated as below. Setup 904 shows the case of a network A having a central unit distributed unit (CU/DU) configuration.

### SCG Activate/Deactivate

In the Rel17, UE can indicate SCG activate/Deactivate preference by bring the below elements in the UAI.

TABLE 4

```
  uplinkData-r17 ENUMERATED { true } OPTIONAL,
  scg-DeactivationPreference ENUMERATED { scgDeactivationPreferred,
noPreference } OPTIONAL,
```

For the MUSIM, if the UE decides to deactivate the SCG, the UE can also include the similar indication in the MUSIM UAI, e.g.

When the UE need to establish the connection with the network B and prefer to deactivate the SCG of the Network A, then the UE can indicate scgDeactivationPreferred

When the UE release the connection with the network B but without any suspended UL data on network A, it can indicate noPreference

When the UE release the connection with the network B and has suspended UL data on network A, it can indicate uplinkData

### SCG Release Vs SCG Activate/Deactivate

Whether to release or deactivate the SCG, it can be determined by either the UE or the network Side, e.g.

If determined by the UE, only one solution was indicated, otherwise, both preference was indicated, then it's up to the network to determine the final solution

### Scell Deactivate

For some cases, the UE may need to deactivate some scells when the UE need to establish connection with network B. For these cases, the UE can indicate the corresponding cell Index to the network. For this scheme, the legacy MAC CE can also be adopted. For the case that the UE also need to indicate the reduced capability for the remaining Activated serving cells, it's better to adopt UAI, then it's up to the network to determine whether to reconfigure UE.

### Scell Release

For the scell release, normally, the UE would indicate the maximum CC numbers in the UAI. However, for the MUSIM, the UE may also need to indicate dedicate Scell if there is collision.

### Scell Release Vs Scell Activate/Deactivate

If both options can work from the UE side, the UE can determine its preference or send both preferences to the network, then the network can make the final decision.
Option 1: Scell Release a list of Scells
Option 2: Scell Deactivate a list of Scells

### 2.4.2 Solutions Combination

According to the above discussion, it may be seen that for the different cases, the UE may indicate different preference. Even for the same case, the UE may have different solutions. For example, when the UE is working at the CA mode with network A, the UE can release/Deactivate Scell with/without capability update on the remaining serving cells, or the UE only need to update the capability limitation. Some possibilities are shown in Table 5.

TABLE 5

| | Release/Deactivate scell | | |
|---|---|---|---|
| | without capability | Release/Deactivate scell | only capability |
| | update | with capability update | update |
| SCell 1: MIMO 4 | Cell 1−>Release or | Cell 1: MIMO 2 | Cell 1: MIMO 2 |
| SCell 2: MIMO 2 | Deactivate | Cell 2−>Release or | Cell 2: SISO |
| PCell 3: MIMO 2 | | Deactivate | Cell 3: SISO |

Furthermore, the network may also indicate which kind of UE capability restriction was supported by the network, e.g.
SCG release/Deactivate
Scell release/Deactivate
Feature Sets limitation
Max CC/MIMO layer limitation

Some preferred embodiments may incorporate the following solutions.

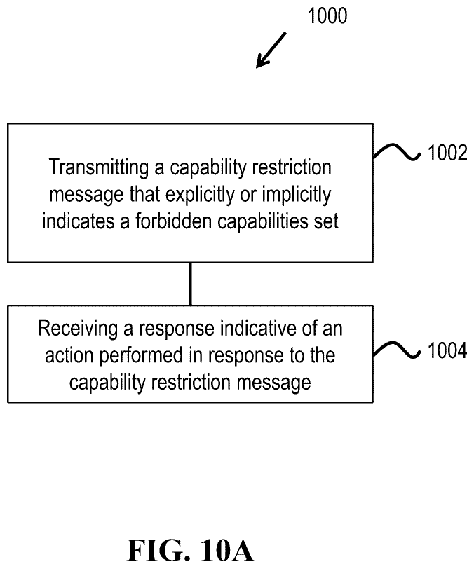

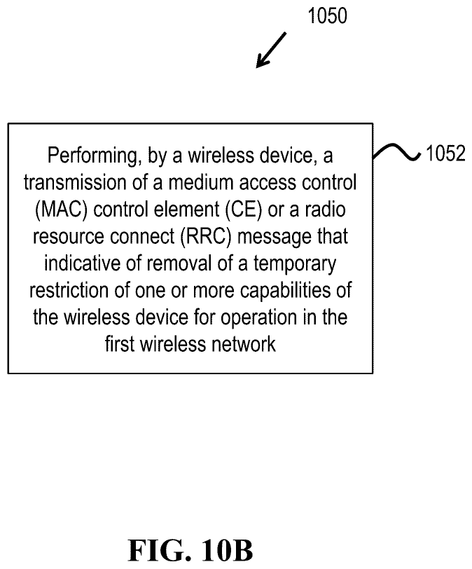

1. A method of wireless communication (e.g., method 1000 depicted in FIG. 10A), comprising: transmitting (1002), by a wireless device, to a first network device of a first wireless network a capability restriction message indicative of a temporary restriction of one or more capabilities of the wireless device for operation in the first wireless network, wherein the capability restriction message indicates a forbidden capabilities set using an explicit indication in which bit fields indicating a first set of capabilities subject to the temporary restriction are included, or an implicit indication in which a second set of capabilities subject to the temporary restriction is indicated by omitting corresponding bit fields from the capability restriction message; and receiving (1004), by the wireless device, from the first network device, a response indicative of an action performed by the first network device in response to the capability restriction message. The method 1000 may be implemented by a UE, e.g., UE that includes the SIM identities depicted in FIGS. 1, 2, 6, 7 and 8.

2. The method of solution 1, wherein the response includes a reconfiguration message.

3. The method of solution 1 or 2, wherein the response includes an accept or a reject message.

4. The method of any of solutions 1-3, wherein the response comprises a medium access control control element (MAC CE).

5. The method of any of solutions 1-4, wherein the capability restriction message includes a third set of capabilities that is not subjected to the temporary restriction.

6. The method of any of solutions 1-5, wherein the forbidden capabilities set includes one or more forbidden frequency band combinations.

7. The method of any of solutions 1-5, wherein the wireless device indicates a secondary cell group (SCG release/deactivate or a secondary cell (Scell) release/deactivate implicitly in the capability restriction message.

8. The method of any of solutions 1-6, wherein the forbidden capabilities set includes one or more forbidden frequency bands.

9. The method of any of solutions 1-8, wherein the forbidden capabilities set includes one or more feature sets combination entry of one or more frequency band combinations that are not forbidden.

10. The method of any of solutions 1-8, wherein the forbidden capabilities set includes one or more feature sets combination entry of a frequency band combination that is forbidden.

11. The method of any of solutions 1-8, wherein the forbidden capabilities set includes one or more feature sets of a frequency band that is not forbidden.

12. The method of any of solutions 1-8, wherein the forbidden capabilities set includes one or more feature sets of a frequency band that is forbidden.

13. The method of any of solutions 1-9, further including transmitting, by the wireless device, to the first network device of the first wireless network a frequency band or band combination configured for the wireless device for communication with a second network device of a second wireless network.

14. A method of wireless communication (e.g., method 1050 depicted in FIG. 10B), comprising: performing (1052), by a wireless device, to a network device, a transmission of a medium access control (MAC) control element (CE) or a radio resource connect (RRC) message that indicative of removal of a temporary restriction of one or more capabilities of the wireless device for operation in the first wireless network. The method 1050 may be implemented by a UE, e.g., UE that includes the SIM identities depicted in FIGS. 1, 2, 6, 7 and 8.

15. The method of solution 14, including: receiving, by the wireless device, from the network device, a response indicative of an action performed by the network device in response to the transmission of the MAC CE or the RRC message.

16. The method of solution 14 or 15, wherein the transmission indicates that the user device is indicating that the temporary capability restriction has been removed.

17. The method of any of solutions 15-16, wherein the response indicates that the network device has restored a capability set that was in use prior to the temporary restriction was activated.

18. The method of any of solutions 15-17, wherein the response indicates that the network device has restored the one or more capabilities of the wireless device that were restricted in the temporary restriction.

19. The method of any of solutions 15-18, wherein the response indicates that the network device has received the request on removing the temporary capability restriction.

20. The method of any of solutions 15-19, wherein the response comprises an RRC msg or a MAC CE.

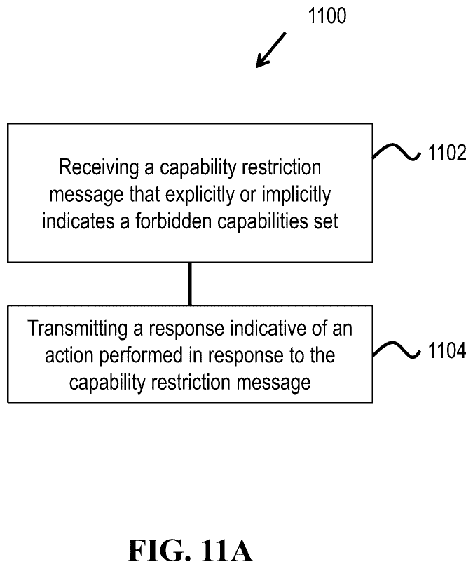

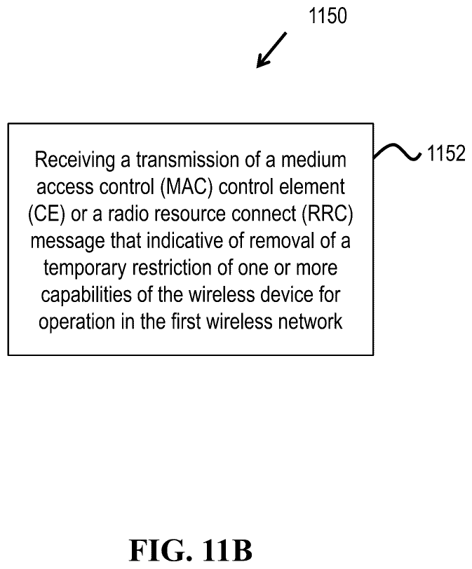

21. A method of wireless communication (e.g., method 1100 depicted in FIG. 11A), comprising: receiving (1102) by a first network device of a first wireless network, from a wireless device, a capability restriction message indicative of a temporary restriction of one or more capabilities of the wireless device for operation in the first wireless network, wherein the capability restriction message indicates a forbidden capabilities set using an explicit indication in which bit fields indicating a first set of capabilities subject to the temporary restriction are included, or an implicit indication in which a second set of capabilities subject to the temporary restriction is indicated by omitting corresponding bit fields from the capability restriction message; and transmitting (1104), by the first network device to the wireless device, a response indicative of an action performed by the first network device in response to the capability restriction message. The method 1100 may be implemented by base station A depicted in FIGS. 1, 2, 6, 7 and 8.

22. The method of solution 21, wherein the response includes a reconfiguration message.

23. The method of solution 21 or 22, wherein the response includes an accept or a reject message.

24. The method of any of solutions 21-23, wherein the response comprises a medium access control control element (MAC CE).

25. The method of any of solutions 21-24, wherein the capability restriction message includes a third set of capabilities that is not subjected to the temporary restriction.

26. The method of any of solutions 21-25, wherein the forbidden capabilities set includes one or more forbidden frequency band combinations.

27. The method of any of solutions 21-25, wherein the wireless device indicates a secondary cell group (SCG release/deactivate or a secondary cell (Scell) release/deactivate implicitly in the capability restriction message.

28. The method of any of solutions 21-27, wherein the forbidden capabilities set includes one or more forbidden frequency bands.

29. The method of any of solutions 21-28, wherein the forbidden capabilities set includes one or more feature sets combination entry of one or more frequency band combinations that are not forbidden.

30. The method of any of solutions 21-28, wherein the forbidden capabilities set includes one or more feature sets combination entry of a frequency band combination that is forbidden.

31. The method of any of solutions 21-28, wherein the forbidden capabilities set includes one or more feature sets of a frequency band that is not forbidden.

32. The method of any of solutions 21-28, wherein the forbidden capabilities set includes one or more feature sets of a frequency band that is forbidden.

33. The method of any of solutions 21-29, further including: receiving, by first network device of the first wireless network, from the wireless device, a frequency band or band combination configured for the wireless device for communication with a second network device of a second wireless network.

34. A method of wireless communication (e.g., method 1150 depicted in FIG. 11B), comprising: receiving (1152) by network device from a wireless device, a transmission of a medium access control (MAC) control element (CE) or a radio resource connect (RRC) message that indicative of removal of a temporary restriction of one or more capabilities of the wireless device for operation in the first wireless network. The method 1150 may be implemented by base station A depicted in FIGS. 1, 2, 6, 7 and 8.

35. The method of solution 34, including: transmitting, by the network device to the wireless device, a response indicative of an action performed by the network device in response to the transmission of the MAC CE or the RRC message.

36. The method of solution 33 or 34, wherein the transmission indicates that the user device is indicating that the temporary capability restriction has been removed.

37. The method of any of solutions 35-36, wherein the response indicates that the network device has restored a capability set that was in use prior to the temporary restriction was activated.

38. The method of any of solutions 35-37, wherein the response indicates that the network device has restored the one or more capabilities of the wireless device that were restricted in the temporary restriction.

39. The method of any of solutions 35-38, wherein the response indicates that the network device has received the request on removing the temporary capability restriction.

40. The method of any of solutions 35-39, wherein the response comprises an RRC msg or a MAC CE.

41. A wireless communication apparatus comprising a processor configured to implement a method recited in any of solutions 1-40.

42. A computer-readable medium having processor-executable code stored thereupon, the code, upon execution by the processor, causing the processor to implement a method recited in any of solutions 1-40.

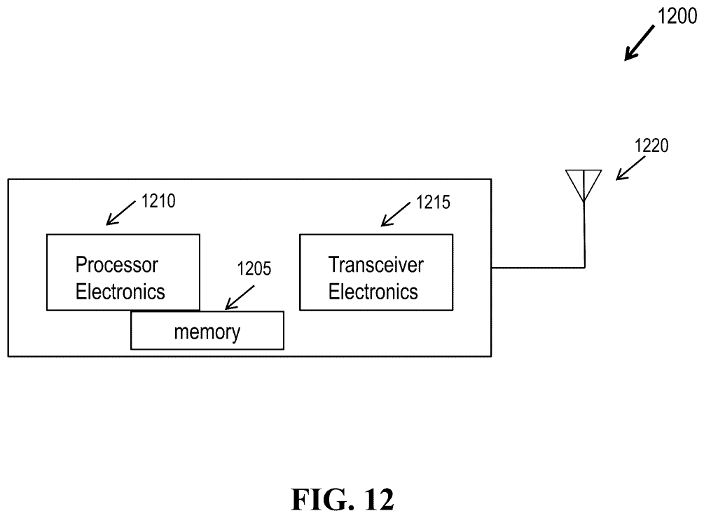

FIG. 12 is a block diagram of an example implementation of a wireless communication apparatus 1200. The methods 400 or 500 may be implemented by the apparatus 1200. In some embodiments, e.g., when implementing method 400, the apparatus 1200 may be a base station or a network device of a wireless network. In some embodiments, e.g., when implementing method 500, the apparatus 1200 may be a user device. The apparatus 1200 includes one or more processors, e.g., processor electronics 1210, transceiver circuitry 1215 and one or more antenna 1220 for transmission and reception of wireless signals. The apparatus 1200 may include memory 1205 that may be used to store data and instructions used by the processor electronics 1210. The apparatus 1200 may also include an additional network interface to one or more core networks or a network operator's additional equipment. This additional network interface, not explicitly shown in FIG. 6, may be wired (e.g., fiber or Ethernet) or wireless.

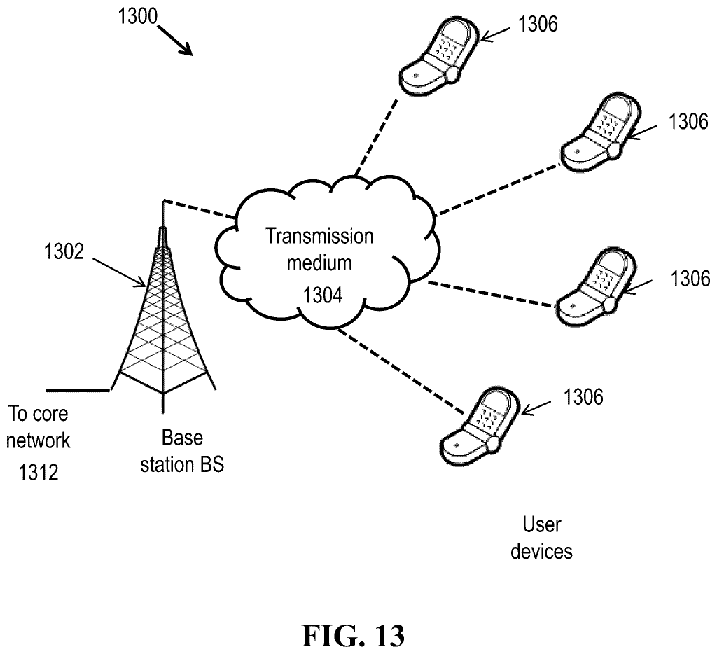

FIG. 13 depicts an example of a wireless communication system 1300 in which the various techniques described herein can be implemented. The system 1300 includes a base station 1302 that may have a communication connection with core network (1312) and to a wireless communication medium 1304 to communicate with one or more user devices 1306. He user devices 1306 could be smartphones, tablets, machine to machine communication devices, Internet of Things (IoT) devices, and so on.

It will be appreciated that techniques that provide allow temporary restriction of capabilities of a UE while operating in one or more wireless networks are described. In one advantageous aspect, the disclosed techniques may be used by embodiments to use an explicit indication, e.g., enumerating capabilities to be restricted or by using an implicit indication, e.g., providing a listing of capabilities that will be supported, meaning that if a capability is not in this list, then it is to be restricted. In some embodiments, certain capabilities of supported band combinations may be restricted, without restricting out the entire band combination.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
transmitting, by a wireless device, to a first network device of a first wireless network a capability restriction message indicative of a temporary restriction of one or more capabilities of the wireless device for operation in the first wireless network, wherein the capability restriction message indicates a forbidden capabilities set using an explicit indication in which bit fields indicating a first set of capabilities subject to the temporary restriction are included, or an implicit indication in which a second set of capabilities subject to the temporary restriction is indicated by omitting corresponding bit fields from the capability restriction message; and
receiving, by the wireless device, from the first network device, a response indicative of an action performed by the first network device in response to the capability restriction message.

2. The method of claim 1, wherein the response includes i) a reconfiguration message, ii) an accept or a reject message, or iii) a medium access control control element (MAC CE).

3. The method of claim 1, wherein the capability restriction message includes a third set of capabilities that is not subjected to the temporary restriction.

4. The method of claim 1, wherein the forbidden capabilities set includes at least one of followings: i) one or more forbidden frequency band combinations, ii) one or more forbidden frequency bands, iii) one or more feature sets combination entry of one or more frequency band combinations that are not forbidden, iv) one or more feature sets combination entry of a frequency band combination that is forbidden, v) one or more feature sets of a frequency band that is not forbidden, or vi) one or more feature sets of a frequency band that is forbidden.

5. The method of claim 1, wherein the wireless device indicates a secondary cell group (SCG) release/deactivate or a secondary cell (Scell) release/deactivate implicitly in the capability restriction message.

6. The method of claim 1, further including:
transmitting, by the wireless device, to the first network device of the first wireless network a frequency band or band combination configured for the wireless device for communication with a second network device of a second wireless network.

7. A method of wireless communication, comprising:
performing, by a wireless device, to a network device, a transmission of a medium access control (MAC) control element (CE) or a radio resource connect (RRC) message that indicative of removal of a temporary restriction of one or more capabilities of the wireless device for operation in a first wireless network, and
receiving, by the wireless device, from the network device, a response indicative of an action performed by the network device in response to the transmission of the MAC CE or the RRC message.

8. The method of claim 7, wherein the transmission indicates that the wireless device is indicating that the temporary capability restriction has been removed.

9. The method of claim 7, wherein the response indicates that the network device has restored a capability set that was in use prior to the temporary restriction was activated, wherein the response indicates that the network device has restored the one or more capabilities of the wireless device that were restricted in the temporary restriction, or wherein the response indicates that the network device has received a request on removing the temporary capability restriction.

10. The method of claim 7, wherein the response comprises an RRC msg or a MAC CE.

11. A method of wireless communication, comprising:
receiving, by a first network device of a first wireless network, from a wireless device, a capability restriction message indicative of a temporary restriction of one or more capabilities of the wireless device for operation in the first wireless network, wherein the capability restriction message indicates a forbidden capabilities set using an explicit indication in which bit fields indicating a first set of capabilities subject to the temporary restriction are included, or an implicit indication in which a second set of capabilities subject to the temporary restriction is indicated by omitting corresponding bit fields from the capability restriction message; and
transmitting, by the first network device to the wireless device, a response indicative of an action performed by the first network device in response to the capability restriction message.

12. The method of claim 11, wherein the response includes i) a reconfiguration message, ii) an accept or a reject message, or iii) a medium access control control element (MAC CE).

13. The method of claim 11, wherein the capability restriction message includes a third set of capabilities that is not subjected to the temporary restriction.

14. The method of claim 11, wherein the forbidden capabilities set includes at least one of following: i) one or more forbidden frequency band combinations, ii) one or more forbidden frequency bands, iii) one or more feature sets combination entry of one or more frequency band combinations that are not forbidden, iv) one or more feature sets combination entry of a frequency band combination that is forbidden, v) one or more feature sets of a frequency band that is not forbidden, or vi) one or more feature sets of a frequency band that is forbidden.

15. The method of claim 11, wherein the wireless device indicates a secondary cell group (SCG) release/deactivate or a secondary cell (Scell) release/deactivate implicitly in the capability restriction message.

16. The method of claim 11, further including:
receiving, by first network device of the first wireless network, from the wireless device, a frequency band or band combination configured for the wireless device for communication with a second network device of a second wireless network.

17. A method of wireless communication, comprising:
receiving, by network device from a wireless device, a transmission of a medium access control (MAC) control element (CE) or a radio resource connect (RRC) message that indicative of removal of a temporary restriction of one or more capabilities of the wireless device for operation in a first wireless network; and
transmitting, by the network device to the wireless device, a response indicative of an action performed by the network device in response to the transmission of the MAC CE or the RRC message.

18. The method of claim 17, wherein the transmission indicates that the wireless device is indicating that the temporary capability restriction has been removed.

19. The method of claim 17, wherein the response indicates that the network device has restored a capability set that was in use prior to the temporary restriction was activated, wherein the response indicates that the network device has restored the one or more capabilities of the wireless device that were restricted in the temporary restriction, or wherein the response indicates that the network device has received a request on removing the temporary capability restriction.

20. The method of claim 17, wherein the response comprises an RRC msg or a MAC CE.
